(19) United States
(12) Patent Application Publication
(10) Pub. No.: US 2017/0223970 A1
(43) Pub. Date: Aug. 10, 2017

(54) METHOD FOR PREPARING A DOUGH COMPRISING ADDITION OF PENICILLIUM GLUCOSE OXIDASE

(71) Applicant: DSM IP ASSETS B.V., Heerlen (NL)

(72) Inventors: Lambertus Gerhard STRUBBE, Echt (NL); Caroline Hendrine Maria VAN BENSCHOP, Echt (NL); Soon Hee ONG, Echt (NL); José DIAS PERES, Echt (NL)

(21) Appl. No.: 15/515,384

(22) PCT Filed: Oct. 1, 2015
(86) PCT No.: PCT/EP2015/072676

§ 371 Date: Mar. 29, 2017

(30) Foreign Application Priority Data
Oct. 2, 2014 (EP) 14187539.3
Oct. 6, 2014 (EP) 14187792.8

(51) Int. Cl. A21D 8/04; A21D 6/00; A23L 7/104; A21D 2/16

(52) U.S. Cl. CPC A21D 8/042; A21D 2/16; A21D 6/001; A23L 7/107

(57) ABSTRACT

The present invention relates to a method for preparing a dough which is to be stored frozen, which method comprises including a Penicillium glucose oxidase in the dough during preparation of the dough.

Further the present invention relates to a frozen dough comprising a Penicillium glucose oxidase and to a method for preparing a baked product, which method comprises baking a frozen dough comprising a Penicillium glucose oxidase.

Baked product prepared from a frozen dough comprising a Penicillium glucose oxidase are described and the use of a Penicillium glucose oxidase in the preparation of a frozen dough.

### FIELD OF THE INVENTION

The present invention relates to a method for preparing doughs, in particular to a method for preparing frozen doughs.

### BACKGROUND OF THE INVENTION

In order to separate dough production and baking and sales of bread products it is common to freeze dough pieces after the dough is formed. The dough having a reduced temperature of below 0° C. is referred to herein as “frozen dough”. Often the temperature is lowered to about −35° C. in a short time period, which is referred to as “shock freezing”. After shock-freeing the dough is packed in plastic and stored for several weeks or months during which period distribution to the baking location can take place. Alternatively the temperature of the dough is lowered more gradually to a reduced temperature in the range of −18 to −20 degrees Celsius.

Frozen dough has several advantages for the bakery industry such as a reduction of night labour, better flexibility in production and allowing bakeries to offer a broader assortment of fresh breads.

Frozen dough is subject to stress due to the freezing and frequently shows different behaviour as compared to dough that is kept at a temperature of above 0° C. during the whole bread making process. Frozen dough frequently shows extended fermentation (proofing) times after thawing, loss of product stability and handling tolerance, reduced baked product volume, loss of shape, coarse crumb structure, blister formation, increased and uneven crust browning.

In order to reduce the negative effect of freezing, specially developed and selected ingredients are applied in frozen dough. Especially, in order to optimize gluten strength, increased levels of oxidative ingredients, such as ascorbic acid are used. Also the enzyme glucose oxidase (GOX), such as the commercially available Aspergillus glucose oxidase, is commonly used in frozen dough to improve dough strength, to improve product appearance or to stabilize volume and shape.

The glucose oxidases which are presently used in frozen dough have some disadvantages, including that they shorten the dough, they result in loss of extensibility and/or they result in elasticity of the dough. The baked products produced from such doughs usually have a coarse crumb structure and frequently off-flavors are experienced in these baked products.

### SUMMARY OF THE INVENTION

In one aspect the present invention relates to a method for preparing a dough which is to be stored frozen, which method comprises including a Penicillium glucose oxidase in the dough during preparation of the dough.

In another aspect, the present invention relates to a frozen dough comprising a Penicillium glucose oxidase.

In another aspect, the present invention relates to a method for preparing a baked product, which method comprises baking a frozen dough comprising a Penicillium glucose oxidase.

In another aspect, the present invention relates to baked product prepared from a frozen dough comprising a Penicillium glucose oxidase.

In another aspect, the present invention relates to the use of a Penicillium glucose oxidase for preparing a frozen dough.

### DESCRIPTION OF THE SEQUENCE LISTING

SEQ ID No.1 sets out the amino acid sequence of the Penicillium glucose oxidase used in the method according to the invention. Amino acids 1 to 18 represent the signal sequence used for secretion of the Penicillium glucose oxidase enzyme (amino acids 19-604).

SEQ ID No.2 sets out the cDNA sequence encoding the Penicillium glucose oxidase depicted in FIG. 1. Nucleotides 1 to 54 encode the signal sequence, nucleotides 55 to 1816 encode the mature glucose oxidase, including a translational termination sequence (5′-TAAA-3′) at the 3′-terminus.

### SHORT DESCRIPTION OF THE FIGURES

FIG. 1. Amino acid sequence of the Penicillium glucose oxidase used in the method according to the invention. Amino acids 1 to 18 represent the signal sequence used for secretion of the glucose oxidase (amino acids 19-604).

FIG. 2. cDNA sequence encoding the Penicillium glucose oxidase depicted in FIG. 1. Nucleotides 1 to 54 encode the signal sequence, nucleotides 55 to 1816 encode the mature glucose oxidase, including a translational termination sequence (5′-TAAA-3′) at the 3′-terminus.

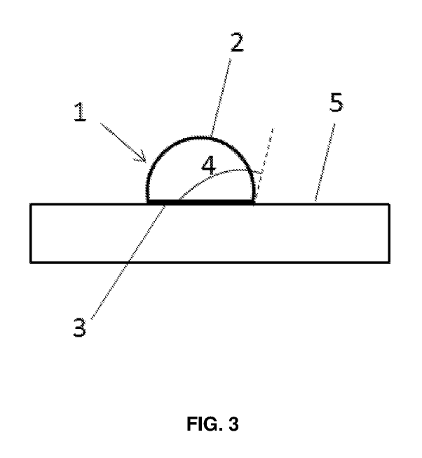

### DETAILED DESCRIPTION OF THE INVENTION

Throughout the present specification and the accompanying claims, the words “comprise”, “include” and “having” and variations such as “comprises”, “comprising”, “includes” and “including” are to be interpreted inclusively. That is, these words are intended to convey the possible inclusion of other elements or integers not specifically recited, where the context allows.

The articles “a” and “an” are used herein to refer to one or to more than one (i.e. to one or at least one) of the grammatical object of the article. By way of example, “an element” may mean one element or more than one element.

The present invention relates to a method for improving a dough which is to be stored frozen, which method comprises including a Penicillium glucose oxidase in the dough during preparation of the dough.

In an embodiment the method according to the invention for preparing a dough which is to be stored frozen comprises:
a) preparing the dough including the step of adding a Penicillium glucose oxidase to at least one dough ingredient; and
b) cooling the dough to a temperature in the range of −35 to −5 degrees Celsius.

In an aspect the method according to the invention is a method for preparing a frozen dough which method comprises:
a) preparing the dough including the step of adding a Penicillium glucose oxidase to at least one dough ingredient; and
b) cooling the dough to a temperature in the range of −35 to −5 degrees Celsius to obtain a frozen dough.

In an aspect of the invention, a method of the invention is a method to prepare a frozen dough, which method comprises the steps (i) adding a Penicillium glucose oxidase to at least one dough ingredient; (ii) preparing the dough; and (iii) cooling the dough to a temperature in the range of −35 to −5 degrees Celsius.

In an aspect of the invention, a method of the invention is a method to prepare a frozen dough, which method comprises the steps (i) adding a Penicillium glucose oxidase to at least one dough ingredient; (ii) preparing the dough; and (iii) cooling the dough to a temperature in the range of −35 to −5 degrees Celsius, wherein the Penicillium glucose oxidase comprises an amino acid sequence as set out in amino acids 19 to 604 of SEQ ID NO. 1.

In an aspect of the method according to the invention the Penicillium glucose oxidase is added in an amount of 1 to 50 ppm based in weight of flour.

The phrase “incorporating into the dough” or “including in the dough” is defined herein as adding the enzyme according to the invention to the dough, to any ingredient from which the dough is to be made (i.e. to any dough ingredient), and/or to any mixture of dough ingredients from which the dough is to be made. In other words, the enzyme may be added in any step of the dough preparation and may be added in one, two or more steps. The enzyme is added to the ingredients of a dough that is kneaded and baked to make the baked product using methods well known in the art. See, for example, U.S. Pat. No. 4,567,046, EP-A-426,211, JP-A-60-78529, JP-A-62-111629, and JP-A-63-258528.

The enzyme is incorporated, included or added in an effective amount. The term “effective amount” is defined herein as an amount of the enzyme that is sufficient for providing a measurable effect on at least one property of interest of the dough and/or baked product.

An effective amount includes a range of 1-50 ppm by weight of flour of a Penicillium glucose oxidase having an activity in a range of about 2500-4000, of about 2800-4000, of about 3000-4000 or of about 3000-3600 glucose oxidase units/gram enzyme. In another embodiment, 1 ppm-30 ppm by weight of flour of a Penicillium glucose oxidase having an activity in a range of about 2500-4000, of about 2800-4000, of about 3000-4000 or of about 3000-3600 glucose oxidase units/gram enzyme is applied. In another embodiment, 1 ppm-20 ppm by weight of flour of a Penicillium glucose oxidase having an activity in a range of about 2500-4000, of about 2800-4000, of about 3000-4000 or of about 3000-3600 glucose oxidase units/gram enzyme is applied. Glucose oxidase activity is preferably determined as described herein.

The Penicillium glucose oxidase, may be any Penicillium glucose oxidase. In an aspect the Penicillium glucose oxidase has an amino acid having at least 75%, at least 80%, at least 85%, at least 90%, at least 95%, at least 97%, at least 98% or at least 99% identity to amino acids 19-604 of SEQ ID No. 1.

The method according to the invention for preparing a dough (a frozen dough or a dough which is to be stored frozen) results in an improved property of the dough and/or in an improved property of the baked product made from the dough.

Herein the phrase “baked product made from the dough” means a baked product made from the dough that was thawed after it was frozen.

The frozen dough according to the invention comprises a Penicillium glucose oxidase. In an aspect of the invention, a frozen dough of the invention is a frozen dough, wherein the Penicillium glucose oxidase comprises an amino acid sequence as set out in amino acids 19 to 604 of SEQ ID NO. 1.

The frozen dough according to the invention has at least one improved property as described herein or results in at least one improved property in a baked product made from the dough.

The use according to the invention of the Penicillium glucose oxidase in the preparation of a frozen dough results in at least one improved property as described herein.

The improved property is a property which is relevant in the preparation of a baked product.

The term “improved property” is defined herein as any property of a dough and/or a product obtained from the dough, particularly a baked product, which is improved by the action of the Penicillium glucose oxidase.

The improved property may be determined after thawing the frozen dough according to the invention, i.e. after thawing a frozen dough comprising a Penicillium glucose oxidase or after thawing a frozen dough obtained by any method according to the invention. In an aspect the improved property of the frozen dough is determined after thawing a frozen dough.

The improved property is determined as compared with a reference not comprising the Penicillium glucose oxidase. The reference may be a dough without a glucose oxidase (herein referred as Control) or may be a dough comprising a different glucose oxidase such as an Aspergillus glucose oxidase. The improved property may be demonstrated by preparing a baked product from a dough comprising a Penicillium glucose oxidase, and preparing another baked product from a dough not comprising a Penicillium glucose oxidase, determining the property of both products and comparing the results.

The improved property may include any one or more of the following, but is not limited to, increased strength of the dough, increased elasticity of the dough, increased dough stability, reduced stickiness of the dough, improved extensibility of the dough, improved machineability of the dough, increased volume of the baked product, improved flavor of the baked product, improved crumb structure of the baked product, improved crumb softness of the baked product and/or reduced blistering of the baked product.

The improved property may be determined by comparison of a dough and/or a baked product prepared with and without addition of Penicillium glucose oxidase in accordance with the methods of present invention.

A baked product prepared from a frozen dough in which a Penicillium glucose oxidase was included during preparation of the dough, has reduced or no off-flavour when compared to a baked product prepared from a frozen dough which does not include a Penicillium glucose oxidase, in particular compared to a baked product prepared from a frozen dough which comprises an Aspergillus glucose oxidase

A dough comprising a Penicillium glucose oxidase shows increased dough stability compared to a dough which does not comprise a Penicillium glucose oxidase.

In the context of the present invention, the term ‘dough’ is defined as a mixture of flour and other dough ingredients. In one embodiment, the dough is firm enough to knead or roll.

Dough is made using at least one dough ingredient. Dough ingredients include without limitation (cereal) flour, a lecithin source including egg, water, salt, sugar, flavours, a fat source including butter, margarine, oil and shortening, baker's yeast, chemical leavening systems such as a combination of an acid (generating compound) and bicarbonate, a protein source including milk, soy flour, non-chemical oxidants (including ascorbic acid, bromate and azodicarbonamide (ADA), reducing agents (including L-cysteine), emulsifiers (including mono- and diglycerides, such as glycerol monostearate (GMS), sodium stearoyl lactylate (SSL), calcium stearoyl lactylate (CSL), polyglycerol esters of fatty acids (PGE) and diacetyl tartaric acid esters of mono- and diglycerides (DATEM), propylene glycerol monostearate (PGMS) and lecithin, gums (including guar gum pectins and xanthan gum), flavours, acids (including citric acid, propionic acid), starch, modified starch, gluten, humectants (including glycerol) and preservatives.

Dough is usually made from basic dough ingredients including (cereal) flour, such as wheat flour or rice flour, water and optionally salt. Cereals include maize, rice, wheat, barley, sorghum, millet, oats, rye, triticale, buckwheat, quinoa, spelt, einkorn, emmer, durum and kamut.

For leavened products, primarily baker's yeast is used next to chemical leavening systems such as a combination of an acid or acid generating compound and bicarbonate. The dough may be made using a mix, including a bread mix.

Frozen doughs have several advantages compared to fresh doughs, e.g. frozen doughs facilitate dough distribution to smaller bakeries. It also facilitates production planning and allows bakeries to produce bread on demand. Time of baking, sale and consumption of the baked product may be weeks or even months later than the production of the dough. In one embodiment, the dough for the preparation of a frozen dough is unproofed (also called unfermented) and frozen immediately after forming, moulding or shaping the dough. In another embodiment, the dough for the preparation of a frozen dough is proofed and frozen. In one embodiment, the dough comprising a Penicillium glucose oxidase is quickly frozen in a blast freezer at approximately −35 degrees Celsius for 45 minutes. After the inner temperature of the dough has reached a temperature of −7 degrees Celsius or lower, the dough pieces were wrapped in plastic bags and stored in a storage freezer. In one embodiment, the dough pieces were wrapped in plastic bags and stored in a storage freezer, once the inner temperature of the dough pieces had reached a temperature in the range of −10 degrees Celsius to −15 degrees Celsius.

In an aspect the frozen dough prepared according to the method of the invention has good dough handling properties after thawing the frozen dough. Dough handling properties include properties which are important for conveniently making portions of dough, conditioning the dough and transporting the dough to dough forming equipment. In an aspect the frozen dough prepared according to the method of the invention after thawing demonstrates good machinability. In an aspect the frozen dough prepared according to the method of the invention demonstrates after thawing reduced dough stickiness to machines used in the bread making process compared to a reference dough. In an aspect the frozen dough according to the invention after thawing shows reduced dough stickiness to machines used in the bread making process compared to a reference dough.

The method of the invention results in an increased dough stability. In the context of the present invention, the term “increased dough stability” means that the dough is less susceptible to forming faults as a consequence of the freezing process. “Dough stability” is also referred to herein as dough stability of the dough.

This can be observed by the thawed, fermented and shaped dough maintaining better its shape during the time from before entering the oven until after baking.

Before entering the oven herein means of from half an hour before until 1 minute before entering the oven. In an aspect before entering the oven means of from 15 minutes before until 1 minute before entering the oven, in an aspect of from 5 minutes before until 2 minutes before entering the oven.

The dough stability may be evaluated by determining the diameter to height (D:H) ratio of the product baked from the dough, which is the average diameter divided by the height.

$$diameter to height ( D \text{:} H ) ratio = \frac{average diameter}{height}$$

The average diameter is determined by measuring the diameter in one direction and adding to this the diameter perpendicular to the one direction and dividing the sum of the diameters by two. All diameters and heights are measured on the surface of the non-sliced (i.e. whole) product. Typically, the D:H ratio of a baked product prepared from a frozen dough comprising Penicillium glucose oxidase is more favourable than the D:H ratio of a baked product prepared from a frozen dough not comprising Penicillium glucose oxidase, even after long periods of freezing of the dough. For rolls, a D:H ratio of 1.4-1.7 is favourable.

Dough stability may be evaluated by comparing the shape of the thawed dough before it enters the oven and the shape of the baked product obtained after baking. Dough stability is improved if these shapes are more similar, i.e differ less from each other, than the corresponding shapes of the reference. This can for example be determined by comparing the diameter to height ratio of the dough and the baked product made from the dough as described herein. If these ratios are similar, the shapes of the dough and the baked product are considered to be similar.

Alternatively dough stability may be evaluated by looking at the roundness of the base of the baked product, a rounder shape of the base indicates a better dough stability. Alternatively dough stability may be evaluated by determining the contact area of the base of the baked product with a surface on which it rests, a smaller contact area indicates an increased dough stability.

During preparation (e.g. mixing), fermentation and baking of the dough the cells are formed and developed to result in a crumb structure of a baked product. Crumb structure is important property of a baked product such as bread or cake is crumb structure. Crumb structure herein is used to describe the inside of a baked product such as bread or cake. Crumb structure is at the way the cell structure of the crumb is formed, and the shape and size of the cells.

Different baked product applications benefit from a different crumb structure. There is therefore a need to modify the crumb structure of a baked product. In certain applications it is desired that the baked product has finer crumb structure.

The present invention relates to the use of a Penicillium glucose oxidase for improving the crumb structure of a baked product prepared from the frozen dough. In an aspect of the use according to the invention, said use is a use of a Penicillium glucose oxidase to provide a baked product prepared from a frozen dough having an improved crumb structure as compared a reference baked product prepared from a frozen dough.

In an embodiment of the use according to the invention, said use is a use of a Penicillium glucose oxidase to create a finer crumb structure of a baked product prepared from a frozen dough.

In an aspect of the use according to the invention, said use is a use of a Penicillium glucose oxidase to provide a baked product prepared from a frozen dough having a finer crumb structure as compared a reference baked product prepared from a frozen dough.

The use of the Penicillium glucose oxidase may be by Penicillium glucose oxidase as an enzyme product.

The use according to the invention may be by Penicillium glucose oxidase as part of a composition, a pre-mix, i.e. in the form of a composition comprising Penicillium glucose oxidase. Said composition may comprise a Penicillium glucose oxidase having an amino acid sequence having at least 75% identity to amino acids 19-604 of SEQ ID No. 1 and a dough ingredient and/or an additional enzyme.

The use according to the invention may be by Penicillium glucose oxidase as part of a composition, i.e. by use of Penicillium glucose oxidase in the form of a composition comprising Penicillium glucose oxidase, such as a composition comprising Penicillium glucose oxidase having an amino acid sequence having at least 75% identity to amino acids 19-604 of SEQ ID No. 1 and a dough ingredient and/or an additional enzyme.

The use according to the invention may be by Penicillium glucose oxidase as part of a pre-mix, i.e. by use of Penicillium glucose oxidase in the form of a pre-mix comprising Penicillium glucose oxidase, such as a pre-mix comprising a Penicillium glucose oxidase having an amino acid sequence having at least 75% identity to amino acids 19-604 of SEQ ID No. 1 and a dough ingredient and/or an additional enzyme.

A frozen dough comprising Penicillium glucose oxidase not only allows for the preparation of baked products which have good dough stability, but also allows for baked products with an improved crumb structure. Baked products baked from a frozen dough comprising Penicillium glucose oxidase, generally have an improved flavour compared baked products prepared from frozen dough comprising Aspergillus glucose oxidase. Baked products baked from a frozen dough comprising Penicillium glucose oxidase, generally have improved taste and/or aroma compared to baked products prepared from frozen dough comprising Aspergillus glucose oxidase.

Therefore, in another aspect, the present invention relates to a frozen dough prepared from a dough in which Penicillium glucose oxidase, such as a Penicillium glucose oxidase having an amino acid sequence which has at least 75%, at least 80%, at least 85%, at least 90%, at least 95%, at least 97%, at least 98% or at least 99% identity to amino acids 19-604 of SEQ ID No. 1, was included before freezing.

The dough for use in the method according to the invention may be prepared in any convenient way. The preparation of a dough from the dough ingredients is well known in the art and includes mixing of dough ingredients and optionally one or more moulding and fermentation steps.

The Penicillium glucose oxidase may added to the at least one dough ingredient in the form of a composition. In one embodiment of the method according to the invention to prepare a dough which is to be stored frozen, the dough is prepared by adding a composition comprising a Penicillium glucose oxidase, such as a Penicillium glucose oxidase having an amino acid sequence which shows at least 75%, at least 80%, at least 85%, at least 90%, at least 95%, at least 97%, at least 98% or at least 99% identity to amino acids 19-604 of SEQ ID No. 1, to at least one dough ingredient. The composition may comprise between 0.001% and 100% w/w of a Penicillium glucose oxidase based on total protein. Preferably, the composition comprises between 1% and 70% w/w of a Penicillium glucose oxidase based on total protein. In one embodiment, the composition comprises between 1% and 50% w/w of a Penicillium glucose oxidase based on total protein. In yet another embodiment, the composition comprises between 1% and 30% w/w of a Penicillium glucose oxidase based on total protein. In yet another embodiment, the composition comprises between 5% and 20% w/w of a Penicillium glucose oxidase based on total protein. The composition may comprise between 0.001% and 100% w/w of a Penicillium glucose oxidase based on total enzyme protein. Preferably, the composition comprises between 1% and 70% w/w of a Penicillium glucose oxidase based on total enzyme protein. In one embodiment, the composition comprises between 1% and 50% w/w of a Penicillium glucose oxidase based on total enzyme protein. In yet another embodiment, the composition comprises between 1% and 30% w/w of a Penicillium glucose oxidase based on total enzyme protein. In yet another embodiment, the composition comprises between 5% and 20% w/w of a Penicillium glucose oxidase based on total enzyme protein. Total enzyme protein refers to all enzyme protein present in the composition.

The Penicillium glucose oxidase may be the only enzymatic component in the composition that is added to the at least one dough ingredient. In another embodiment of the invention, the composition comprises a Penicillium glucose oxidase and at least one additional enzyme. The at least one additional enzyme activity may be selected from enzymes like a protease, such as an endoprotease or an exoprotease; a peptidase, such as an exopeptidase or an endopeptidase; a lipolytic enzyme, such as a triacyl glycerol lipase, a phospholipase, a galactolipase or an enzyme having both phospholipase and galactolipase activity; or a carbohydrase, such as a cellulase, a hemicellulase, in particular a pentosanase such as a xylanase; a cross-linking enzyme, such as a transglutaminase; a maltogenic alpha amylase; an alpha amylase or a beta amylase; an amyloglucosidase, an oxidase, such as a sulfhydryl oxidase, a pyranose oxidase; a peroxidase, a hexose oxidase, a laccase; a protein disulfide isomerase; an asparaginase.

In an aspect the composition as described herein comprises the Penicillium glucose oxidase as described herein and one or more components selected from the group consisting of milk powder, gluten, granulated fat, an additional enzyme, an amino acid, a salt, an oxidant such as ascorbic acid, a reducing agent such as L-cysteine, an emulsifier such as mono-glycerides, di-glycerides, glycerol monostearate, sodium stearoyl lactylate, calcium stearoyl lactylate, polyglycerol esters of fatty acids and diacetyl tartaric acid esters of mono- and diglycerides, gums such as guargum and xanthangum, flavours, acids such as citric acid and propionic acid, starch, modified starch, gluten, humectants such as glycerol, and preservatives. The additional enzyme may be selected from enzymes like a protease, such as a endoprotease or an exoprotease; a peptidase, such as an exopeptidase or an endopeptidase; a lipolytic enzyme, such as a triacyl glycerol lipase, a phospholipase, a galactolipase or an enzyme having both phospholipase and galactolipase activity; or a carbohydrase, such as a cellulase, a hemicellulase, in particular a pentosanase such as a xylanase; a cross-linking enzyme, such as a transglutaminase; a maltogenic alpha amylase; a further amylase such as a further alpha amylase or a beta amylase; an oxidase, a peroxidase, an hexose oxidase, a glucose oxidase, a laccase; a protein disulfide isomerase; an asparaginase

The Penicillium glucose oxidase may added to the at least one dough ingredient in the form of a bread improving composition. Typically a bread improving composition is added to improve functionalities of the dough or of the baked product made from the dough. The improvement is in comparison to a dough or baked product which is prepared without using the bread improver and may be reflected in any functionality of the dough or baked product from the dough, such as increased strength of the dough, increased viscoelasticity of the dough, increased dough stability of the dough, reduced stickiness of the dough, improved extensibility of the dough, improved machinability of the dough, increased volume of the baked product, improved flavour of the baked product, improved crumb structure of the baked product, improved crumb softness of the baked product, reduced blistering of the baked product, improved crispiness, improved resilience both initial and in particular after storage, reduced hardness after storage or improved anti-staling properties of the baked product.

In one embodiment, the composition which is added to the at least one dough ingredient is added to improve crumb structure of the baked product and/or to reduce blistering of the baked product.

The term “increased strength of the dough” is defined herein as the property of a dough that has generally more viscoelastic properties and/or requires more work input to mould and shape.

In the context of the present invention, the term “increased viscoelasticity of the dough” means that the dough has a higher tendency to regain its original shape after being subjected to a certain physical strain, such as stretching.

The term “increased dough stability” is defined herein as the property of a dough that is less susceptible to forming faults as a consequence of freezing or frozen storage, thus better maintaining its shape and volume. It may be evaluated by the D:H ratio as described above. Alternatively may be evaluated by looking at the roundness of the base of the baked product, a rounder shape indicates a better dough stability. Alternatively it may be evaluated by determining the contact area of the base of the baked product with a surface on which it rests, a smaller contact area indicates an increased dough stability. “Increased dough stability” may also be referred to as “increased stability of a dough”.

The term “reduced stickiness of the dough” is defined herein as the property of a dough that has less tendency to adhere to surfaces, e.g., in the dough production machinery and/or dough transporting equipment. It is either evaluated empirically by the skilled test baker or measured by a suitable system known in the art, such as Warburtons dough stickiness system. Reduced dough stickiness, also referred to herein as reduced stickiness of the dough, may be determined by methods known in the art, such as by evaluation by a skilled baker or by using a texture analyser. In one embodiment, reduced dough stickiness is determined in a Warburtons dough stickiness system. Preferably dough stickiness is determined at ambient temperature. Ambient temperature may typically be between 20 and 30 degrees Celsius.

Dough stickiness may be evaluated through tactile assessment for example while shaping the dough. Alternatively dough stickiness may be evaluated after shaping the dough, by touching the surface of the shaped dough and sensing how much it sticks to the fingers. If the dough sticks less to the fingers than a reference it is evaluated as having a reduced dough stickiness. Alternatively dough stickiness may be evaluated after cutting the dough, by touching the surface of the freshly cut dough surface and sensing how much it sticks to the fingers. If the dough sticks less to the fingers than a reference it is evaluated as having a reduced dough stickiness.

The term “improved extensibility of the dough” is defined herein as the property of a dough that can be subjected to increased strain or stretching without rupture.

The term “improved flavour of the baked product” herein includes the property of a baked product having reduced or no off-flavour.

The term “improved machinability of the dough” is defined herein as the property of a dough that is generally less sticky and/or more firm and/or more elastic. Consequently there is less fouling of plant equipment and a reduced need for cleaning.

The term “improved crumb structure of the baked product” is defined herein as the property of a baked product with finer cells and/or thinner cell walls in the crumb and/or more uniform/homogenous distribution of cells in the crumb and is usually evaluated visually by the baker or by digital image analysis as known in the art (e.g. C-cell, Calibre Control International Ltd, Appleton, Warrington, UK).

In an aspect of the present invention the term “improved crumb structure of the baked product” is defined as a more uniform/homogeneous crumb structure.

In an aspect of the present invention the term “improved crumb structure of the baked product” is defined as a finer crumb structure.

The parameter concerning evaluation of the crumb structure may be determined my digital analysis of a slice of baked product e.g. a slice of bread or cake.

In an aspect when comparing parameters of a baked product with a reference baked product, the parameter is normalized with respect to the total surface area of the reference slice of baked product that was analyzed. The total surface area of a slice of bread may be provided by the digital analysis apparatus or may be established by multiplying the height and the width of the slice involved.

In an aspect when comparing parameters of a baked product with a reference baked product, the parameter is normalized with respect to the volume of the reference baked product that was analyzed. The volume of the baked product may be determined by an automated bread volume analyser (such as an BVM-3, TexVol Instruments).

A more uniform/homogeneous crumb structure of a baked product may be shown by the area of holes, as determined by digital image analysis, being smaller than the area of holes of a reference baked product.

A finer crumb structure of a baked product may be shown by a higher number of cells per mm², as determined by digital image analysis, than the number of cells per mm² of a reference baked product.

A finer crumb structure of a baked product may be shown by a smaller average cell diameter, as determined by digital image analysis, than the average cell diameter of a reference baked product.

A finer crumb structure of a baked product herein includes smaller cells, smaller holes and /or less holes as compared to a reference baked product.

In an aspect a finer crumb structure of a baked product herein includes smaller cells, smaller holes and less holes as compared to a reference baked product.

In an aspect a finer crumb structure of a baked product herein includes smaller average cell diameter and a smaller average hole diameter as compared to a reference baked product.

In an aspect a finer crumb structure of a baked product herein includes smaller average cell diameter, a smaller average hole diameter and/or less holes as compared to a reference baked product.

In an aspect a finer crumb structure of a baked product herein includes smaller average cell diameter, a smaller average hole diameter and less holes as compared to a reference baked product.

In an aspect an improved crumb structure of a baked product herein includes smaller average cell diameter, a smaller average hole diameter, less holes and/or a more uniform/homogenous distribution of cells as compared to a reference baked product.

In an aspect an improved crumb structure of a baked product herein includes smaller average cell diameter, a smaller average hole diameter, less holes and a more uniform/homogenous distribution of cells as compared to a reference baked product.

The term “improved softness of the baked product” is the opposite of “hardness” and is defined herein as the property of a baked product that is more easily compressed and is evaluated either empirically by the skilled test baker or measured by the use of a texture analyzer known in the art.

The term “reduced blistering of the baked product” is defined herein as a visually determined reduction of blistering on the crust of the baked bread.

The term “improved anti-staling properties of the baked product” is defined herein as the properties of a baked product that have a reduced rate of deterioration of quality parameters, e.g. reduced hardness after storage and/or decreased loss of resilience after storage. Anti-staling properties may be demonstrated by a reduced hardness after storage of the baked product. The enzyme composition according to the invention or the pre-mix according to the invention may result in reduced hardness, e.g. in a baked product that is more easily compressed. The hardness of the baked product may be evaluated either empirically by the skilled test baker or measured by the use of a texture analyzer known in the art. The hardness measured within 24 hours after baking is called initial hardness. The hardness measured 24 hours or more after baking is called hardness after storage, and is also a measure for determining shelf life. In case the initial hardness has reduced, it has improved. In case the hardness after storage has reduced, it has improved. Resilience of the baked product is preferably measured by the use of a texture analyzer known in the art. The resilience measured within 24 hours after baking is called initial resilience. The resilience measured 24 hours or more after baking is called resilience after storage, and is also a measure for determining shelf life. Freshly baked product typically gives crumb of high initial resilience but resilience is lost over shelf-life. Improved anti-staling properties may be demonstrated by a reduced loss of resilience over storage.

Organoleptic qualities, such as taste, aroma and/or (off-)flavour may be evaluated using procedures well established in the baking industry, and may include, for example, the use of a panel of trained taste-testers.

The composition comprising a Penicillium glucose oxidase may further comprises one or more components selected from the group consisting of milk (including liquid milk and milk powder), gluten, granulated fat, an additional enzyme, an amino acid, a salt, an oxidant such as ascorbic acid, bromate and azodicarbonamide; a reducing agent such as L-cysteine, an emulsifier such as mono-and diglycerides, glycerol monostearate, sodium stearoyl lactylate, calcium stearoyl lactylate, polyglycerol esters of fatty acids and diacetyl tartaric acid esters of mono- and diglycerides, propylene glycerol monostearate (PGMS) and lecithin, gums such as guar gum and xanthan gum, flavours, acids such as citric acid and propionic acid, starch, modified starch, humectants such as glycerol, and preservatives. In another embodiment, the composition comprises a lipolytic enzyme, preferably a phospholipase. In another embodiment, the composition comprises an alpha amylase.

The composition comprising a Penicillium glucose oxidase, such as a Penicillium glucose oxidase comprising an amino acid sequence which shows at least 75%, at least 80%, at least 85%, at least 90%, at least 95%, at least 97%, at least 98% or at least 99% identity to amino acids 19-604 of SEQ ID NO. 1, may be formulated in any suitable form. In one embodiment, the composition is formulated in a dry form, such as a freeze-dried or spray-dried powder or a granulate. In another embodiment, the composition is in liquid form, such as in the form of an emulsion, a suspension or a solution. In yet another embodiment, is a paste or a gel.

The Penicillium glucose oxidase may added to the at least one dough ingredient in the form of a pre-mix. In another embodiment, the dough for use in the method according to the invention is prepared from a pre-mix or flour comprising a Penicillium glucose oxidase. The term “pre-mix” is defined herein to be understood in its conventional meaning, i.e. as a mix of baking agents, generally including flour, which may be used not only in industrial bread-baking plants/facilities, but also in retail bakeries. The pre-mix may be prepared by mixing a Penicillium glucose oxidase or a composition according to the invention with a suitable carrier such as flour, starch or a salt. A suitable pre-mix may include, in addition to flour, at least one additive selected from non-chemical oxidants (including ascorbic acid, bromate and azodicarbonamide (ADA), reducing agents (including L-cysteine), emulsifiers (including mono- and diglycerides, such as glycerol monostearate (GMS), sodium stearoyl lactylate (SSL), calcium stearoyl lactylate (CSL), polyglycerol esters of fatty acids (PGE) and diacetyl tartaric acid esters of mono- and diglycerides (DATEM), propylene glycerol monostearate (PGMS) and lecithin, gums (including guar gum pectins and xanthan gum), flavours, acids (including citric acid, propionic acid), starch, modified starch, gluten, humectants (including glycerol) and preservatives. A suitable additive includes propylene glycerol monostearate (PGMS). In one embodiment of the method according to the invention the dough is prepared using a pre-mix comprising 1 to 50 ppm by weight of flour of a Penicillium glucose oxidase, for example a Penicillium glucose oxidase with an amino acid sequence which has at least 75%, at least 80%, at least 85%, at least 90%, at least 95%, at least 97%, at least 98% or at least 99% identity to amino acids 19-604 of SEQ ID No. 1. In one embodiment, a flour comprising 1 ppm-50 ppm by weight of flour of a Penicillium glucose oxidase having an activity in a range of about 2500-4000, of about 2800-4000, of about 3000-4000 or of about 3000-3600 glucose oxidase units/gram enzyme is used to prepare a dough according to a method of the present invention. In another embodiment, 1 ppm-20 ppm by weight of flour of a Penicillium glucose oxidase having an activity in a range of about 2500-4000, of about 2800-4000, of about 3000-4000 or of about 3000-3600 glucose oxidase units/gram enzyme is used to prepare a dough according to a method of the present invention.

In one embodiment of the method according to the invention a dough is prepared from a flour comprising 1 to 50 ppm by weight of flour of a Penicillium glucose oxidase, for example a Penicillium glucose oxidase with an amino acid sequence which has at least 75%, at least 80%, at least 85%, at least 90%, at least 95%, at least 97%, at least 98% or at least 99% identity to amino acids 19-604 of SEQ ID No. 1. In one embodiment, a flour comprising 1 ppm-50 ppm by weight of flour of a Penicillium glucose oxidase having an activity in a range of about 2500-4000, of about 2800-4000, of about 3000-4000 or of about 3000-3600 glucose oxidase units/gram enzyme is used to prepare a dough according to a method of the present invention. In another embodiment, 1 ppm-20 ppm by weight of flour of a Penicillium glucose oxidase having an activity in a range of about 2500-4000, of about 2800-4000, of about 3000-4000 or of about 3000-3600 glucose oxidase units/gram enzyme is used to prepare a dough according to a method of the present invention.

In one embodiment, the frozen dough is stored frozen for at least one month, at least two months, at least three months, at least four months, at least five months, at least six months, at least seven, eight or ten months. In another embodiment, the frozen dough is stored frozen for at least one year. Freezing may be done at any suitable temperature and is typically done at least minus 15 degrees Celsius. In an aspect freezing is done at least minus 18 degrees Celsius, in an aspect at least minus 20 degrees Celsius.

In another aspect, the invention provides a method to prepare a baked product comprising the steps of
a) thawing a frozen dough comprising a Penicillium glucose oxidase, such as a Penicillium glucose oxidase having an amino acid sequence which shows at least 75%, at least 80%, at least 85%, at least 90%, at least 95%, at least 97%, at least 98% or at least 99% identity to amino acids 19-604 of SEQ ID No. 1; and
b) thereafter baking the thawed dough.

The baking of the dough to produce a baked product may be performed using methods well known in the art. In one embodiment of the invention, the baked product according to the invention is bread, such as a bread roll.

In another aspect, the present invention relates to a baked product prepared from a frozen dough in which dough Penicillium glucose oxidase, such as a Penicillium glucose oxidase with an amino acid sequence which shows at least 75%, at least 80%, at least 85%, at least 90%, at least 95%, at least 97%, at least 98% or at least 99% identity to amino acids 19-604 of SEQ ID No. 1, was included before freezing. The preparation of baked products from frozen dough is well known in the art. Typically, the frozen dough is allowed to slowly thaw and then the process may comprise moulding and shaping and fermentation of the dough followed by baking at required temperatures and baking times.

Examples of baked products, whether of a white, brown or whole-meal type, which may be advantageously produced by the present invention include bread (in particular white, whole-meal or rye bread), typically in the form of loaves or rolls, French baguette-type bread, pastries, croissants, brioche, panettone, pasta, noodles (boiled or (stir-)fried), pita bread and other flat breads, tortillas, tacos, pancakes, cookies in particular biscuits, doughnuts, including yeasted doughnuts, bagels, pie crusts, steamed bread, crisp bread, brownies, snack foods (e.g., pretzels, tortilla chips, fabricated snacks, fabricated potato crisps). The term baked product includes, bread containing from 2 to 30 wt % sugar, fruit containing bread, breakfast cereals, cereal bars, soft rolls and gluten-free bread. Gluten free bread herein and herein after is bread than contains at most 20 ppm gluten. Several grains and starch sources are considered acceptable for a gluten-free diet. Frequently used sources are potatoes, rice and tapioca (derived from cassava). Baked product includes without limitation tin bread, loaves of bread, twists, soft pretzels, soft and hard bread, bread sticks buns, such as hamburger buns or steamed buns, focaccia, Middle Eastern and Asian flat breads; such as pita, lavash, chapati, paratta, nan, dried steam bun slice, bread crumb, matzos, melba toast, rusk, zwieback, croutons, yeast leavened and chemically-leavened bread, laminated dough products such as Danish pastry, croissants or puff pastry products, muffins, anish bagels, confectionery coatings, crackers, wafers, pizza crusts, tortillas, pasta products, crepes, waffles and par-baked products. An example of a par-baked product includes, without limitation, partially baked bread that is completed at point of sale or consumption with a short second baking process.

The bread may be white, brown or whole meal bread. The term tortilla as used herein includes corn tortilla and wheat tortilla. A corn tortilla is a type of thin, flat bread, usually unleavened, made from finely ground maize (usually called corn in the US). A flour tortilla is a type of thin, flat bread, usually unleavened, made from finely ground wheat flour. The term tortilla further includes a similar bread from South America called arepa, though arepas are typically much thicker than tortillas. The term tortilla further includes a laobing, a pizza-shaped thick “pancake” from China and an Indian Roti, which is made essentially from wheat flour. A tortilla usually has a round or oval shape and may vary in diameter from about 6 to over 30 cm.

Baked products obtained by using a dough prepared according to the method of the invention are also encompassed by the present invention. All the embodiments which were mentioned above for the dough, with all the preferences mentioned above, also apply to the flour and baked products according to the invention.

In an aspect a baked product prepared from a frozen dough comprising Penicillium glucose oxidase shows improved crumb structure, when compared to a baked product prepared from a frozen dough which does not include a Penicillium glucose oxidase.

In an aspect a baked product prepared from a frozen dough comprising Penicillium glucose oxidase shows improved taste and aroma, when compared to a baked product prepared from a frozen dough which does not include a Penicillium glucose oxidase, in particular compared to a baked product prepared from a frozen dough which comprises an Aspergillus glucose oxidase.

In an aspect a baked product prepared from a frozen dough comprising Penicillium glucose oxidase shows improved flavour of the baked product, when compared to a baked product prepared from a frozen dough which does not include a Penicillium glucose oxidase, in particular compared to a baked product prepared from a frozen dough which comprises an Aspergillus glucose oxidase.

In an aspect a baked product prepared from a frozen dough comprising Penicillium glucose oxidase shows reduced or no off-flavour, when compared to a baked product prepared from a frozen dough which does not include a Penicillium glucose oxidase, in particular compared to a baked product prepared from a frozen dough which comprises an Aspergillus glucose oxidase

In an aspect a baked product prepared from a frozen dough comprising Penicillium glucose oxidase shows improved crumb structure and an improved flavour of the baked product, when compared to a baked product prepared from a frozen dough which does not include a Penicillium glucose oxidase, in particular compared to a baked product prepared from a frozen dough which comprises an Aspergillus glucose oxidase.

A dough comprising a Penicillium glucose oxidase shows an increased dough stability, when compared to a dough which does not comprise a Penicillium glucose oxidase, in an aspect when compared to a dough which comprises an Aspergillus glucose oxidase.

In another aspect, the present invention relates to the use of a Penicillium glucose oxidase for preparing a frozen dough.

The present invention relates to the use of a Penicillium glucose oxidase for improving the crumb structure of a baked product prepared from a frozen dough. The present invention relates to the use of a Penicillium glucose oxidase for increasing the dough stability of a dough which has been stored frozen.

The present invention relates to the use of a Penicillium glucose oxidase in the production of a roll, for obtaining a roll having a diameter to height ratio in the range of 1.4 to 1.7, whereby this ratio is determined as described in the present application.

The present invention relates to the use of a Penicillium glucose oxidase for a combination of two or more of these uses.

A Penicillium glucose oxidase for use according to the invention may be obtained by any suitable means. In one embodiment, it is isolated from a source, in particular a prokaryotic or eukaryotic microorganism, containing the enzyme. Suitable examples of microorganisms are mammalian, plant, fungal and algal microorganisms as mentioned below. In one embodiment, the Penicillium glucose is isolated from a Penicillium species, in particular from Penicillium chrysogenum. A suitable example of such a Penicillium glucose oxidase is a Penicillium glucose oxidase comprising an amino acid sequence according to amino acids 19-604 of SEQ ID NO. 1 or a glucose oxidase with an amino acid sequence which shows at least 75% identity to amino acids 19-604 of SEQ ID No.1. In one embodiment, the glucose oxidase has an amino acid sequence which shows at least 80%, at least 85%, at least 90%, at least 95%, at least 97%, at least 98% or at least 99% identity to amino acids 19-604 of SEQ ID NO. 1.

In another embodiment, the Penicillium glucose oxidase is generated using standard molecular biology techniques to provide a glucose oxidase which would otherwise be obtainable from a Penicillium fungus, e.g. by de novo synthesis of a nucleotide sequence according to SEQ ID No. 2 or a nucleotide sequence which encodes a protein having an amino acid sequence having at least 75%, at least 80%, at least 85%, at least 90%, at least 95%, at least 97%, at least 98% or at least 99% identity to amino acids 19-604 of SEQ ID No.1. In one embodiment, a nucleotide sequence according to SEQ ID No. 2 is used. Such a nucleotide sequence may then be used for transformation of a host microorganism. In another embodiment, the Penicillium glucose oxidase is generated using site-saturation mutagenesis, scanning mutagenesis, insertional mutagenesis, random mutagenesis, site-directed mutagenesis, and directed-evolution of an existing glucose oxidase, e.g. of the one depicted in SEQ ID NO. 1, as well as various other recombination approaches known to a skilled person in the art. Glucose oxidases (EC 1.1.3.4) catalyse the oxidation of glucose into gluconic acid and hydrogen peroxide using atmospheric oxygen.

In the context of the present invention, in order to determine the percentage of sequence identity of two amino acid sequences or of two nucleic acid sequences, the sequences are aligned for optimal comparison purposes. In order to optimize the alignment between the two sequences, gaps may be introduced in any of the two sequences that are compared. Such alignment may be carried out over the full length of the sequences being compared. Alternatively, the alignment may be carried out over a shorter length, for example over about 20, about 50, about 100 or more nucleic acids/bases or amino acids. The sequence identity is the percentage of identical matches between the two sequences over the reported aligned region. Upon the alignment of two sequences, the resulting aligned amino acid positions are usually referred to as corresponding positions. The percent sequence identity between two amino acid sequences or between two nucleotide sequences may be determined using the Needleman and Wunsch algorithm for the alignment of two sequences. (Needleman, S. B. and Wunsch, C. D. (1970) J. Mol. Biol. 48, 443-453). Both amino acid sequences and nucleotide sequences can be aligned by the algorithm. The Needleman-Wunsch algorithm has been implemented in the computer program NEEDLE. For the purpose of this invention the NEEDLE program from the EMBOSS package was used (version 2.8.0 or higher, EMBOSS: The European Molecular Biology Open Software Suite (2000) Rice, P. Longden, l. and Bleasby, A. Trends in Genetics 16, (6) p. 276-277, http://emboss.bioinformatics.nl/). For protein sequences EBLOSUM62 is used for the substitution matrix. For nucleotide sequences, EDNAFULL is used. The optional parameters used are a gap-open penalty of 10 and a gap extension penalty of 0.5. The skilled person will appreciate that all these different parameters will yield slightly different results but that the overall percentage identity of two sequences is not significantly altered when using different algorithms.

After alignment by the program NEEDLE as described above the percentage of sequence identity between a query sequence and a sequence of the invention is calculated as follows: Number of corresponding positions in the alignment showing an identical amino acid or identical nucleotide in both sequences divided by the total length of the alignment after subtraction of the total number of gaps in the alignment. The identity as defined herein can be obtained from NEEDLE by using the NOBRIEF option and is labeled in the output of the program as “longest-identity”.

The nucleic acid and protein sequences of the present invention can further be used as a “query sequence” to perform a search against public databases to, for example, identify other family members or related sequences. Such searches can be performed using the NBLAST and XBLAST programs (version 2.0) of Altschul, et al. (1990) J. Mol. Biol. 215:403-10. BLAST nucleotide searches can be performed with the NBLAST program, score=100, word length=12 to obtain nucleotide sequences similar to nucleic acid molecules of the invention. BLAST protein searches can be performed with the XBLAST program, score=50, word length=3 to obtain amino acid sequences similar to protein molecules of the invention. To obtain gapped alignments for comparison purposes, Gapped BLAST can be utilized as described in Altschul et al., (1997) Nucleic Acids Res. 25(17): 3389-3402. When utilizing BLAST and Gapped BLAST programs, the default parameters of the respective programs (e.g., XBLAST and NBLAST) can be used. See the homepage of the National Center for Biotechnology Information at http://www.ncbi.nlm.nih.gov/.

Any microorganism may be used as a recombinant host cell to produce a Penicillium glucose oxidase for use according to the invention. In one embodiment, the microorganism is a prokaryotic cell, such as a Gram-negative or Gram-positive bacterium. Suitable bacteria include Escherichia, Anabaena, Caulobactert, Cyanobacteria, Gluconobacter, Rhodobacter, Pseudomonas, Paracoccus, Bacillus, Brevibacterium, Corynebacterium, Rhizobium (Sinorhizobium), Flavobacterium, Klebsiella, Enterobacter, Lactobacillus, Lactococcus, Methylobacterium, Moraxella, Neisseria, Staphylococcus, Streptomyces or Thermoactinomyces. In another embodiment, the microorganism is a eukaryotic cell, such as a mammalian cell, insect cell, plant cell, fungal cell or algal cell. Suitable examples of mammalian cells are CHO cells, COS cells, 293 cells, Per.C6® cells, and hybridomas. Suitable examples of insect cells include Sf9 and Sf21 cells and derivatives thereof. Suitable examples of fungal cells include yeast cells, such as Candida, Hansenula, Kluyveromyces, Pichia, Saccharomyces, Schizosaccharomyces, or Yarrowia strain; more preferably Kluyveromyces lactis, S. cerevisiae, Hansenula polymorpha, Yarrowia lipolytica and Pichia pastoris, or a filamentous fungi. Filamentous fungi include all filamentous forms of the subdivision Eumycota and Oomycota (as defined by Hawksworth et al., In, Ainsworth and Bisby's Dictionary of The Fungi, 8th edition, 1995, CAB International, University Press, Cambridge, UK). Filamentous fungal strains include strains of Acremonium, Agaricus, Aspergillus, Aureobasidium, Chrysosporium, Coprinus, Cryptococcus, Filibasidium, Fusarium, Humicola, Magnaporthe, Mucor, Myceliophthora, Neocafiimastix, Neurospora, Paecilomyces, Penicillium, Piromyces, Panerochaete, Pleurotus, Rasamsonia, Schizophyllum, Talaromyces, Thermoascus, Thielavia, Tolypocladium, and Trichoderma. Preferred filamentous fungal cells belong to a species of an Aspergillus, Chrysosporium, Myceliophthora, Penicillium, Talaromyces, Fusarium, Rasamsonia, Thermoascus or Trichoderma genus, and most preferably a species of Aspergillus niger, Aspergillus awamori, Aspergillus foetidus, Aspergillus sojae, Aspergillus fumigatus, Aspergillus oryzae, Fusarium oxysporum, Myceliophthora thermophila, Rasamsonia emersonii, Trichoderma reesei, Talaromyces emersonii, Thermoascus aurantiacus or Penicillium chrysogenum. Algae is the group of unicellular and multicellular eukaryortic photosynthetic organisms, including microalgae, such as Dunaliella, Spirulina and Chlorella. Algae include algal host cells and microalgae, such as Schizochitrium. In one embodiment, the recombinant host cell comprising a nucleotide sequence or a nucleic acid molecule according to the invention is an Aspergillus, Bacillus, Chrysosporium, Escherichia, Kluyveromyces, Myceliophthora, Penicillium, Pseudomonas, Rasamsonia, Saccharomyces, Streptomyces or Talaromyces species, preferably a Bacillus subtilis, Bacillus amyloliquefaciens, Bacillus licheniformis, Escherichia coli, Aspergillus niger, Aspergillus oryzae, Myceliophthora thermophila, Rasamsonia emersonii or Trichoderma reesei species. The recombinant host cell is preferably capable of expressing or overexpressing the glucose oxidase, for example as described in WO 2010/121933 or WO 2012/001169. The recombinant host cell, such as a host cell belonging to the genus Aspergillus, may further comprise one or more modifications in its genome such that the recombinant microbial host cell is deficient in the production of at least one product selected from glucoamylase (glaA), acid stable alpha-amylase (amyA), neutral alpha-amylase (amyBI and amyBII), oxalic acid hydrolase (oahA), a toxin, preferably ochratoxin and/or fumonisin, a protease transcriptional regulator prtT, PepA, a product encoded by the gene hdfA and/or hdfB, a non-ribosomal peptide synthase npsE, agsE or amyC if compared to a parent host cell and measured under the same conditions. Suitable methods of producing said host cells include the ones described in WO2012/001169 and WO02014013074.

The glucose oxidase used in the present invention may be fusion proteins. Techniques for producing fusion polypeptides are known in the art, and include ligating the coding sequences encoding the polypeptides so that they are in frame. Expression of the fused polypeptide is under control of the same promoter(s) and terminator. The hybrid polypeptides may comprise a combination of partial or complete polypeptide sequences obtained from at least two different polypeptides wherein one or more may be heterologous to a host cell. Such fusion polypeptides from at least two different polypeptides may comprise a binding domain from one polypeptide, such as a starch binding domain or a carbohydrate binding domain, operably linked to a catalytic domain from a second polypeptide. Examples of fusion polypeptides and signal sequence fusions are for example as described in WO2010/121933, WO2013/007820 and WO2013/007821.

In the context of the present invention the term ‘polypeptide’ refers to a molecule which contains a backbone of a chain of at least ten amino acids, wherein the amino acids are covalently linked to each other by peptide bonds. These backbone amino acids groups may be linked to other groups, such as other amino acid sequences, sugar groups or lipid groups. The polypeptide may contain structural features, such as alpha-helices, beta-pleated sheets or disulphide bridges. A polypeptide used according to the present invention may comprise a catalytic domain and one or more binding domains, such as a starch or carbohydrate binding domain. In the context of the present invention, the amino acid sequence is also referred to as ‘polypeptide sequence’ or ‘protein sequence’. The term ‘polypeptide’ includes proteins.

In the Figures and in other places of the description of the present invention where the one letter code for amino acids is used, A stands for Alanine, C for Cysteine, D or Aspartic acid, E for Glutamic acid, F for Phenylalanine, G for Glycine, H for Histidine, I for Isoleucine, K for Lysine, L for Leucine, M for Methionine, N for Asparagine, P for Proline, Q for Glutamine, R for Arginine, S for Serine, T for Threonine, V for Valine, W for Tryptophan, Y for Tyrosine Such one letter codes are commonly known in the art, see e.g. Sambrook, et al. (Molecular Cloning: A Laboratory Manual, 2^{nd} ed. Cold Spring Harbor Laboratory, Cold Spring Harbor Laboratory Press, Cold Spring Harbor, N.Y., 1989).

The Penicillium glucose oxidase typically has an activity in the range of about 2500 to 4000 glucose oxidase units/gram enzyme when determined according to the assay described below. In one embodiment, the Penicillium glucose oxidase has an activity in the range of about 2800 to 4000 glucose oxidase units/gram enzyme. In another embodiment, the Penicillium glucose oxidase has an activity in the range of about 3000 to 4000 glucose oxidase units/gram enzyme. In yet another embodiment, the Penicillium glucose oxidase has an activity in the range of about 3000 to 3600 glucose oxidase units/gram enzyme. In yet another embodiment, the Penicillium glucose oxidase has an activity of about 3300 glucose oxidase units/gram enzyme. Glucose oxidase activity is determined in an assay in which gluconic acid formed is titrated. 1 ml of diluted glucose oxidase is added to 25 ml of preheated 30 g/I glucose monohydrate solution at 35 degrees C. Sample dilutions and substrate are prepared in 50 mM HAc buffer at pH 5.1, containing 50 mM NaCl. After 15 minutes incubation at 35 degrees C., the reaction is terminated by the addition of 10 ml 0.1 N NaOH, at the same time neutralizing the gluconic acid formed. Excess NaOH is titrated with 0.05 M HCI. The difference in HCI consumption between a sample and blank run is a measure for the amount of glucose oxidase activity. One glucose oxidase unit is defined as the amount of enzyme needed to oxidize 3 mg of glucose to gluconic acid under conditions of the assay.

Glucose oxidase activities may be determined using alternative assays, such as spectrophotometrically at 450 nm using o-dianisidine as described by Witteveen et al. 1990 (“Glucose oxidase overproducing and negative mutants of Aspergillus niger”, Appl. Microbiol. Biotechnol 33:683-686) or a glucose oxidase assay as described in the Food Chemicals Codex (FCC).

In aspect 1 of the invention, a method of the invention is a method for preparing a dough which is to be stored frozen, which method comprises including a Penicilllium glucose oxidase in the dough during preparation of the dough.

In aspect 2 of the invention, a method of the invention is a method according to aspect 1, which method comprises (i) adding a Penicillium glucose oxidase to at least one dough ingredient; (ii) preparing the dough; and (iii) cooling the dough to a temperature in the range of −35 to −5 degrees Celsius.

In aspect 2A of the invention, a method of the invention is a method to prepare a frozen dough, which method comprises the steps (i) adding a Penicillium glucose oxidase to at least one dough ingredient; (ii) preparing the dough; and (iii) cooling the dough to a temperature in the range of −35 to −5 degrees Celsius.

In aspect 2B of the invention, a method of the invention is a method to prepare a frozen dough, which method comprises the steps (i) adding a Penicillium glucose oxidase to at least one dough ingredient; (ii) preparing the dough; and (iii) cooling the dough to a temperature in the range of −35 to −5 degrees Celsius, wherein the Penicillium glucose oxidase comprises an amino acid sequence as set out in amino acids 19 to 604 of SEQ ID NO. 1.

In aspect 3 of the invention, a method of the invention is a method according to aspect 1 or 2, wherein the dough which is to be stored frozen is subjected to shock freezing.

In aspect 3A of the invention, a method of the invention is a method according to aspect 2A or 2B, wherein in step (iii) the dough is subjected to shock freezing.

In aspect 4 of the invention, a method of the invention is a method according to any one of aspects 1 to 3, wherein the dough which is to be stored frozen is frozen as an unproofed dough.

In aspect 5 of the invention, a method of the invention is a method according to any one of aspects 1 to 4, wherein the dough to be stored frozen is stored frozen for at least two months.

In aspect 6 of the invention, a method of the invention is a method according to any one of aspects 1 to 5, wherein the Penicillium glucose oxidase is included or added in an amount of 1 to 50 ppm based in weight of flour.

In aspect 6A of the invention, a method of the invention is a method according to any one of aspects 1A, 2A and 3A, wherein the Penicillium glucose oxidase is added in an amount of 1 to 50 ppm based in weight of flour.

In aspect 7 of the invention, a method of the invention is a method according to any one of aspects 1 to 6, wherein the Penicillium glucose oxidase has an amino acid sequence having at least 75% identity to amino acids 19 to 604 of SEQ ID NO. 1.

In aspect 7A of the invention, a method of the invention is a method according any one of aspects 1 to 6, wherein the Penicillium glucose oxidase comprises an amino acid sequence as set out in amino acids 19 to 604 of SEQ ID NO. 1.

In aspect 8 of the invention, a frozen dough of the invention is a frozen dough comprising a Penicillium glucose oxidase.

In aspect 9 of the invention, a frozen dough of the invention is a frozen dough according to aspect 8, which has been frozen by shock freezing to minus 35 degrees C.

In aspect 10 of the invention, a frozen dough of the invention is a frozen dough according to aspect 8 or 9, which has been stored frozen for at least two months.

In aspect 11 of the invention, a frozen dough of the invention is a frozen dough according to any one of aspects 8 to 10, comprising 1 to 50 ppm of a Penicillium glucose oxidase based in weight of flour.

In aspect 12 of the invention, a frozen dough of the invention is a frozen dough according to any one of aspects 8 to 11, wherein the Penicillium glucose oxidase has an amino acid sequence having at least 75% identity to amino acids 19 to 604 of SEQ ID NO. 1.

In aspect 12A of the invention, a frozen dough of the invention is a frozen dough according to any one of aspects 8 to 11, wherein the Penicillium glucose oxidase comprises an amino acid sequence as set out in amino acids 19 to 604 of SEQ ID NO. 1.

In aspect 13 of the invention, a frozen dough of the invention is a frozen dough prepared by a method according to any one of aspects 1 to 7.

In aspect 14 of the invention, a baked product of the invention is a baked product prepared from a frozen dough according to any one of aspects 8 to 13.

In aspect 14A of the invention, a baked product of the invention is a baked product prepared from a frozen dough according to aspect 12A.

In aspect 15 of the invention, a baked product of the invention is a baked product according to aspect 14, wherein the baked product is selected from the group comprising: bread loaves, bread rolls, French baguette-type bread, pastries, croissants, brioche, dumplings, panettone, pasta, noodles, pizza, pita bread and other flat breads, tortillas, tacos, doughnuts, steamed bread, brownies and snack foods.

In aspect 16 of the invention, a baked product of the invention is a baked product according to aspect 14 or 15, wherein the baked product is a par-baked product.

In aspect 17 of the invention, a baked product of the invention is a baked product according to any one of aspects 14 to 16, wherein the baked product has reduced or no off-flavour in comparison to a baked product which has been prepared from a frozen dough in which Aspergillus glucose oxidase was included or to which no Aspergillus glucose oxidase was added.

In aspect 18 of the invention, a baked product of the invention is a baked product according to any one of aspects 14 to 17, wherein the baked product is a roll and the diameter to height ratio of the baked product is 1.4-1.7, whereby this ratio is determined as described in the present application.

In aspect 19 of the invention, a baked product of the invention is a baked product according to any one of aspects 14 to 17, wherein has an improved crumb structure in comparison to a baked product which has been prepared from a frozen dough in which no Penicillium glucose oxidase was included or to which no Penicillium glucose oxidase was added.

In aspect 20 of the invention a method of the invention is a method for preparing a baked product, which method comprises baking a frozen dough according to any one of aspects 8 to 13.

In aspect 20A of the invention a method of the invention is a method for preparing a baked product, which method comprises baking a frozen dough according to aspect 12A.

In aspect 21 of the invention, a use of the invention is the use of a Penicillium glucose oxidase in the preparation of a frozen dough.

In aspect 22 of the invention, a use of the invention is the use of a Penicillium glucose oxidase for improving the crumb structure of a baked product prepared from a frozen dough.

In aspect 23 of the invention, a use of the invention is the use of a Penicillium glucose oxidase for increasing the dough stability of a frozen dough.

In aspect 24 of the invention, a use of the invention is the use according to aspect 23, wherein the baked product is a roll and the Penicillium glucose oxidase is used to obtain a baked product with a diameter to height ratio in the range of 1.4 to 1.7, whereby this ratio is determined as described in the present application.

In aspect 25 of the invention, a method of the invention is a method for preparing a baked product comprising the steps of:
a) thawing the frozen dough according to any one of aspects 8 to 13 to obtain a thawed dough; and
b) baking the thawed dough.

In aspect 25A of the invention, a method of the invention is a method for preparing a baked product comprising the steps of:
a) thawing the frozen dough according to aspect 12A to obtain a thawed dough; and
b) baking the thawed dough.

Hereafter the invention is illustrated by the following non-limiting examples.

### EXAMPLES

### Bread Improver

The bread improver used was a mixture of vital wheat gluten, guar gum, emulsifier, flour treatment agent and comprised 150 ppm ascorbic acid (from DSM Nutritional Products, Switzerland), 1 ppm Bakezyme® P500 (fungal alpha-amylase from DSM Food Specialties, The Netherlands), 30 ppm Bakezyme® HSP6000 (fungal hemicellulase from DSM Food Specialties, The Netherlands), 150 ppm Bakezyme® AG1100 (fungal amyloglucosidase from DSM Food Specialties, The Netherlands and Kolibri flour (Meneba, the Netherlands) as filling material up to a dosage level of 1% calculated on the flour weight (Table 1).

Where appropriate in the examples, glucose oxidase was added to these enzymes. ppm based in weight of flour.

### Glucose Oxidases

The Penicillium glucose oxidase used was Penicillium chrysogenum glucose oxidase with a protein sequence as depicted in SEQ ID No.1 prepared by transformation of an Aspergillus with a construct comprising a cDNA sequence as depicted in SEQ ID No. 2 and subsequent expression of the enzyme.

For comparison, BakeZyme® GO10.000 BG, (Aspergillus niger glucose oxidase, from DSM Food Specialties, the Netherlands) was used.

### Glucose Oxidases

The Penicillium glucose oxidase used was Penicillium chrysogenum glucose oxidase with a protein sequence as depicted in SEQ ID No.1 prepared by transformation of an Aspergillus with a construct comprising a cDNA sequence as depicted in SEQ ID No. 2 and subsequent expression of the enzyme.

For comparison, BakeZyme® GO10.000 BG, (Aspergillus tubingensis glucose oxidase, from DSM Food Specialties, the Netherlands) was used.

### Determination of Glucose Oxidase Activity

Glucose oxidase activity was determined in an assay in which gluconic acid formed is titrated. Thereto, 1 ml of diluted glucose oxidase was added to 25 ml of preheated 30 g/l glucose monohydrate solution at 35 degrees C. Sample dilutions and substrate were prepared in 50 mM HAc buffer at pH 5.1, containing 50 mM NaCI. After 15 minutes incubation at 35 degrees C., the reaction was terminated by the addition of 10 ml 0.1 N NaOH, at the same time neutralizing the gluconic acid formed. Excess NaOH was titrated with 0.05 M HCI. The difference in HCI consumption between a sample and blank run is a measure for the amount of glucose oxidase activity. One glucose oxidase unit is defined as the amount of enzyme needed to oxidize 3 mg of glucose to gluconic acid under conditions of the assay.

Activity of Penicillium glucose oxidase used was 3300 glucose oxidase units/gram enzyme. ppm means mg/kg, e.g. 20 ppm means 20 mg of the indicated product per kg flour.

### Determination of Diameter to Height (D:H) Ratio of the Baked Product.

The diameter to height ratio was determined by dividing the average diameter by the height of the baked product.

$$diameter to height ( D \text{:} H ) ratio = \frac{average diameter}{height}$$

The average diameter was determined by measuring the diameter in one direction and adding to this the diameter perpendicular to the one direction and dividing the sum of the diameters by two. All diameters and heights were measured on the surface of the non-sliced (i.e. whole) baked product. For rolls, a diameter to height ratio of 1.4-1.7 was considered favourable.

### Example 1

### The Effect of Penicillium Glucose Oxidase on Baked Product From Frozen Dough.

A bread dough was prepared by mixing and kneading the ingredients listed in Table 1 together with no (Control) or 10 ppm or 20 ppm of a glucose oxidase based on weight of flour.

TABLE 1
Basic bread recipe

| | % based on flour | |
|---|---|---|
| Ingredient | weight | Type |
| Bread flour | 100 | Epi-B, Paniflour, Belgium |
| gluten | 2 | Amygluten 110, Tereos Syral, |
| | | Belgium |
| water | 62 | |
| yeast | 5 | Koningsgist, AB Mauri, |
| | | the Netherlands |
| Salt | 1.8 | Suprasel, Akzo Nobel, |
| | | the Netherlands |
| Bread improver | 1 | See materials & methods |

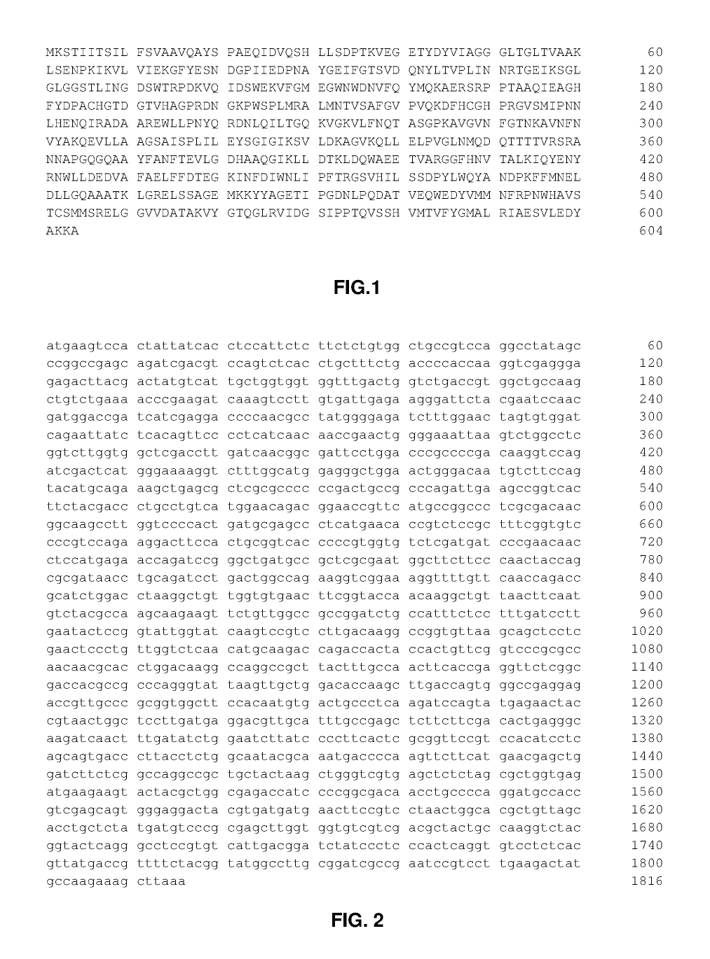

Two glucose oxidases were used, a Penicillium glucose oxidase with an amino acid sequence according to SEQ ID No.1 and FIG. 1, and Aspergillus glucose oxidase (BakeZyme® GO10.000 BG).

The ingredients were kneaded into a well-developed dough with an inner temperature of 20° C. (+/−0.5° C.). Then, the dough was divided into equal dough pieces. (1650 gram /30 pcs), rounded and left to relax for about 5 minutes. The dough was subsequently moulded and quickly frozen in a blast freezer (−35° C.) for 45 minutes. After the inner temperature of the dough had reached a temperature of about −7 degrees Celsius, the dough pieces were wrapped in plastic bags and stored in a storage freezer at −18° C.

After one 1 night (1N) and two months (2M) frozen storage time, dough pieces were taken from the freezer, slowly thawed and warmed up to 28° C. under humidity control at which they proofed until the desired volume. After proofing, they were slashed once, through the skin, with a sharp knife and cut in half.

One half of each dough piece was baked for 20 minutes at 240° C. with injected steam immediately after proofing. This was called the “Normal Proof” or “NP”. The other half of each dough piece was baked 30 minutes after the first half under the same conditions. Since this half had more time to proof, these circumstances were called “Extended Proof” or “EP”. Results for Extended Proof are evaluated in Example 2. Properties of the baked products, such as viscoelasticity, crumb structure, dough stability and taste and aroma, were evaluated.

The dough which included Penicillium glucose oxidase had good handling properties and good viscoelasticity.

The dough stability was evaluated by determining the diameter to height (D:H) ratio of baked rolls prepared from the dough after frozen storage in comparison to a control to which no glucose oxidase was added while preparing the dough. A D:H ratio of 1.4-1.7 was considered to be favourable. The results are presented in Table 2 and show that rolls became wider (increased D:H ratio) upon increased frozen storage time. After a two months storage, the D:H ratio of the control was 2.0, by which it falls outside the favoured range of 1.4-1.7. The D:H ratio of rolls prepared with dough comprising Aspergillus or Penicillium glucose oxidase that had been stored frozen for two months, was within the favoured range of 1.4-1.7. This indicates that the glucose oxidase containing doughs have improved dough stability compared to the control dough.

TABLE 2
D:H ratios of baked rolls in the Normal Proof experiment
with frozen dough stored for various time periods.

| | 1 (control) | 2 | 3 | 4 | 5 |
|---|---|---|---|---|---|
| BakeZyme ® | | 10 ppm | | 20 ppm | |
| GO10.000 BG* | | | | | |
| Penicillium | | | 10 ppm | | 20 ppm |
| glucose oxidase | | | | | |
| stored for 1 Night | 1.7 | 1.6 | 1.6 | 1.6 | 1.5 |
| stored for 2 | 2.0 | 1.7 | 1.7 | 1.6 | 1.6 |
| Months | | | | | |

*(Aspergillus glucose oxidase, from DSM Food Specialties, the Netherlands)
*(Aspergillus tubingensis glucose oxidase, from DSM Food Specialties, the Netherlands)

Visual inspection by experienced bakers showed that the rolls prepared with Penicillium glucose oxidase had finer crumb structure than the rolls prepared with Aspergillus glucose oxidase.

The taste and aroma of the baked products prepared were also evaluated by experienced bakers. Whereas the aroma of the rolls made with Aspergillus glucose oxidase showed an off-flavour, it was noticed that the rolls made with Penicillliumglucose oxidase had a far more neutral aroma.

### Example 2

### The Effect of Penicillium Glucose Oxidase on Baked Product From Frozen Dough After Extended Proofing Time

The other halves of the dough pieces prepared in Example 1 were baked 30 minutes after the first halves under the same conditions and their properties, such as elasticity, crumb structure, dough stability and taste and aroma, were evaluated.

The dough stability from which these baked rolls were prepared was evaluated by determining D:H ratio of the baked rolls after frozen storage of the dough. The results are presented in Table 3.

TABLE 3
D:H ratios of baked rolls in the Extended Proof experiment
with frozen dough stored for various time periods.

| | 1 | | | | |
|---|---|---|---|---|---|
| | (control) | 2 | 3 | 4 | 5 |
| BakeZyme ® | | 10 ppm | | 20 ppm | |
| GO10.000 BG* | | | | | |
| Penicillium | | | 10 ppm | | 20 ppm |
| glucose oxidase | | | | | |
| stored for 1 Night | 1.8 | 1.7 | 1.7 | 1.6 | 1.6 |
| stored for 2 | 2.1 | 1.9 | 1.8 | 1.8 | 1.7 |
| Months | | | | | |

*Aspergillus glucose oxidase, from DSM Food Specialties, the Netherlands
*(Aspergillus tubingensis glucose oxidase, from DSM Food Specialties, the Netherlands)

Rolls became wider (increased D:H ratio) upon increased frozen storage time. After a two months storage, the D:H ratio of the control was 2.1, by which it falls outside the favoured range of 1.4-1.7. The D:H ratio of rolls prepared with dough comprising Aspergillus or Penicillium glucose oxidase was in or close to close to the favoured range of 1.4 to 1.7. This indicates that the glucose oxidase containing doughs have improved dough stability compared to the control dough.

Baking dough made with 20 ppm Penicillium glucose oxidase, after two month of frozen storage, resulted in a baked product having a D:H ratio which still falls within the favourable range of 1.4 to 1.7.

Visual inspection by experienced bakers showed that the rolls prepared with Penicillium glucose oxidase had finer crumb structure than the rolls prepared with Aspergillus glucose oxidase.

The taste and aroma of the baked products were evaluated by experienced bakers. Whereas the aroma of the rolls made with Aspergillus glucose oxidase showed an off-flavour, it was noticed that the rolls made with Penicillium glucose oxidase had a far more neutral aroma.

1. A method for preparing a dough which is to be stored frozen, which method comprises including a Penicillium glucose oxidase in the dough during preparation of the dough.

2. The method according to claim 1, which method comprises:
a) preparing the dough including adding a Penicillium glucose oxidase to at least one dough ingredient; and
b) cooling the dough to a temperature in a range of −35 to −5 degrees Celsius.

3. The method according to claim 1, wherein the dough which is to be stored frozen is frozen as an unproofed dough.

4. The method according to claim 1, wherein the dough to be stored frozen is stored frozen for at least two months.

5. The method according to claim 1, wherein the Penicillium glucose oxidase is included or added in an amount of 1 to 50 ppm base on weight of flour.

6. The method according to claim 1, wherein the Penicillium glucose oxidase has an amino acid sequence having at least 75% identity to amino acids 19 to 604 of SEQ ID NO. 1.

7. A frozen dough comprising a Penicillium glucose oxidase.

8. The frozen dough according to claim 7, which has been stored frozen for at least two months.

9. The frozen dough according to claim 7, comprising 1 to 50 ppm of a Penicillium glucose oxidase.

10. The frozen dough according to claim 7, wherein the Penicillium glucose oxidase has an amino acid sequence having at least 75% identity to amino acids 19 to 604 of SEQ ID NO. 1.

11. A frozen dough prepared by a method according to claim 1.

12. A baked product prepared from a frozen dough according to claim 7.

13. A product comprising Penicillium glucose oxidase used in the preparation of a frozen dough.

14. The product according to claim 13 for improving the crumb structure of a baked product prepared from the frozen dough.

15. The product according to claim 13 to increase the dough stability of the frozen dough.


SEQUENCE LISTING (2 sequences)

SEQ ID NO: 1 - protein, 604 aa, Penicillium chrysogenum
  SIGNAL (1)..(18)
MKSTIITSILFSVAAVQAYSPAEQIDVQSHLLSDPTKVEGETYDYVIAGGGLTGLTVAAKLSENPKIKVLVIEKGFYESNDGPIIEDPNAYGEIFGTSVDQNYLTVPLINNRTGEIKSGLGLGGSTLINGDSWTRPDKVQIDSWEKVFGMEGWNWDNVFQYMQKAERSRPPTAAQIEAGHFYDPACHGTDGTVHAGPRDNGKPWSPLMRALMNTVSAFGVPVQKDFHCGHPRGVSMIPNNLHENQIRADAAREWLLPNYQRDNLQILTGQKVGKVLFNQTASGPKAVGVNFGTNKAVNFNVYAKQEVLLAAGSAISPLILEYSGIGIKSVLDKAGVKQLLELPVGLNMQDQTTTTVRSRANNAPGQGQAAYFANFTEVLGDHAAQGIKLLDTKLDQWAEETVARGGFHNVTALKIQYENYRNWLLDEDVAFAELFFDTEGKINFDIWNLIPFTRGSVHILSSDPYLWQYANDPKFFMNELDLLGQAAATKLGRELSSAGEMKKYYAGETIPGDNLPQDATVEQWEDYVMMNFRPNWHAVSTCSMMSRELGGVVDATAKVYGTQGLRVIDGSIPPTQVSSHVMTVFYGMALRIAESVLEDYAKKA

SEQ ID NO: 2 - DNA, 1816 bp, Penicillium chrysogenum
  signal (1)..(54)
  terminator (1813)..(1816)
atgaagtccactattatcacctccattctcttctctgtggctgccgtccaggcctatagcccggccgagcagatcgacgtccagtctcacctgctttctgaccccaccaaggtcgagggagagacttacgactatgtcattgctggtggtggtttgactggtctgaccgtggctgccaagctgtctgaaaacccgaagatcaaagtccttgtgattgagaagggattctacgaatccaacgatggaccgatcatcgaggaccccaacgcctatggggagatctttggaactagtgtggatcagaattatctcacagttcccctcatcaacaaccgaactggggaaattaagtctggcctcggtcttggtggctcgaccttgatcaacggcgattcctggacccgccccgacaaggtccagatcgactcatgggaaaaggtctttggcatggagggctggaactgggacaatgtcttccagtacatgcagaaagctgagcgctcgcgccccccgactgccgcccagattgaagccggtcacttctacgaccctgcctgtcatggaacagacggaaccgttcatgccggccctcgcgacaacggcaagccttggtccccactgatgcgagccctcatgaacaccgtctccgctttcggtgtccccgtccagaaggacttccactgcggtcacccccgtggtgtctcgatgatcccgaacaacctccatgagaaccagatccgggctgatgccgctcgcgaatggcttcttcccaactaccagcgcgataacctgcagatcctgactggccagaaggtcggaaaggttttgttcaaccagaccgcatctggacctaaggctgttggtgtgaacttcggtaccaacaaggctgttaacttcaatgtctacgccaagcaagaagttctgttggccgccggatctgccatttctcctttgatccttgaatactccggtattggtatcaagtccgtccttgacaaggccggtgttaagcagctcctcgaactccctgttggtctcaacatgcaagaccagaccactaccactgttcggtcccgcgccaacaacgcacctggacaaggccaggccgcttactttgccaacttcaccgaggttctcggcgaccacgccgcccagggtattaagttgctggacaccaagcttgaccagtgggccgaggagaccgttgcccgcggtggcttccacaatgtgactgccctcaagatccagtatgagaactaccgtaactggctccttgatgaggacgttgcatttgccgagctcttcttcgacactgagggcaagatcaactttgatatctggaatcttatccccttcactcgcggttccgtccacatcctcagcagtgacccttacctctggcaatacgcaaatgaccccaagttcttcatgaacgagctggatcttctcggccaggccgctgctactaagctgggtcgtgagctctctagcgctggtgagatgaagaagtactacgctggcgagaccatccccggcgacaacctgccccaggatgccaccgtcgagcagtgggaggactacgtgatgatgaacttccgtcctaactggcacgctgttagcacctgctctatgatgtcccgcgagcttggtggtgtcgtcgacgctactgccaaggtctacggtactcagggcctccgtgtcattgacggatctatccctcccactcaggtgtcctctcacgttatgaccgttttctacggtatggccttgcggatcgccgaatccgtccttgaagactatgccaagaaagcttaaa